(19) United States
(12) Patent Application Publication
(10) Pub. No.: US 2016/0346739 A1
(43) Pub. Date: Dec. 1, 2016

(54) FILTRATION APPARATUS

(71) Applicant: BASF SE, Ludwigshafen (DE)

(72) Inventors: Stefan PANGLISCH, Essen (DE); Peter BERG, Utting (DE); Christian STAAKS, Muenchen (DE); Christian MUELLER, Buchloe (DE)

(73) Assignee: BASF SE, Ludwigshafen (DE)

(21) Appl. No.: 15/116,563

(22) PCT Filed: Feb. 18, 2015
(86) PCT No.: PCT/EP15/53375

§ 371 Date: Aug. 4, 2016

(30) Foreign Application Priority Data
Feb. 19, 2014 (EP) 14155706.6

(51) Int. Cl. B01D 63/04; B01D 61/14; B01D 61/08; B01D 61/02; C02F 1/44; B01D 61/18

(52) U.S. Cl. CPC B01D 63/043; C02F 1/442; C02F 1/444; B01D 61/18; B01D 61/08; B01D 61/027; B01D 61/145; B01D 61/147; C02F 2303/16; B01D 2311/25; B01D 2313/06; B01D 2313/04; B01D 2313/12; B01D 2321/04; B01D 2321/02; B01D 2319/04

(57) ABSTRACT

A filtration apparatus for filtering fluids including a top compartment, a filtration compartment, and a bottom compartment. The filtration compartment includes plural filtration elements arranged in parallel, the filtration elements further including at least one permeate collecting tube, wherein the permeate connecting tube is in fluid communication with the top compartment such that in a filtration operation a continuous permeate flow into a permeate collecting chamber of the top compartment is provided and in a backwash operation permeate collected in the permeate collecting chamber is flushed back through the filtration elements. A method for filtering fluids can use the filtration apparatus.

The invention relates to a filtration apparatus for filtering fluids, such as gases or liquids, in particular raw water, comprising a top compartment, a filtration compartment and a bottom compartment. The invention further relates to a method for filtering fluids using the filtration apparatus as well as the use of the filtration apparatus for filtering fluids.

Water treatment is one of the most vital applications of filtration processes, which thus experience a strong interest not only due to global water scarcity, particularly in drought-prone and environmentally polluted areas, but also due to the continuous need for drinking water supplies and for treatment of municipal or industrial waste water. Typically water treatment relies on a combination of different methods and technologies, which depend on the intended purpose of the purified water as well as on the quality and degree of the contaminated or raw water.

Conventionally, water treatment is based on treatment steps, such as flocculation, sedimentation and multi media filtration. In recent years, however, membrane technologies, such as microfiltration, ultrafiltration, nanofiltration and reverse osmosis, have emerged providing more efficient and reliable filtration processes. Membrane-based processes, such as microfiltration or ultrafiltration, remove turbidity caused by suspended solids and microorganisms such as pathogens like bacteria, germs and viruses from raw water. Further significant advantages of membrane-based processes are that less chemicals and no temperature treatment are required.

Common membranes for filtration are either flat shaped membranes or tubular membranes with one or more capillaries. Typically, such membranes are semi-permeable and mechanically separate permeate or filtrate and the retentate from raw water. Thus, the microfiltration and ultrafiltration membranes allow permeate, such as water, to pass and hold back suspended particles or microorganisms as retentate. In this context vital membrane parameters are the selectivity, the resistance to fouling and the mechanical stability. The selectivity is mainly determined by the pore size usually specified in terms of the exclusion limit given by the nominal molecular weight cut-off (NMWC) in Dalton (Da). The NMWC is usually defined as the minimum molecular weight of a globular molecule retained by the membrane to 90%. For example in ultrafiltration the nominal pore size lies between 50 and 5 nm and the NMWC lies between 5 and 200 kDa. In nanofiltration the pore size lies between 5 and 1 nm and the NMWC lies between 0.2 and 5 kDa. Thus, while ultrafiltration already filters bacteria, viruses and macromolecules leading to water with drinking quality, nanofiltration leads to partially demineralised water. In reverse osmosis the nominal pore size shrinks even further below 1 nm and the NMWC below 200 Da. Reverse osmosis is thus suitable for filtering even smaller entities such as monovalent salts and small organic molecules. In combining the different filtration technologies a wide variety of filtration actions can be achieved which may be adapted to a specific intended purpose. Membranes are usually embedded in a filtration system, which allows to feed the raw water and to discharge the permeate as well as the concentrate. For this purpose filtration systems encompass an inlet as raw water feed and outlets to discharge the permeate and the concentrate. For tubular membranes different designs of filtration systems exist.

In WO 2006/012920 A1 a filtration system for tubular membranes is described. Here the tubular membrane includes multiple capillaries, which are embedded in a porous substrate. The liquid to be filtered flows from or to at least one long inner channel of the capillaries for transporting the liquid to be filtered or filtered liquid. The tubular membrane is disposed in a tubular housing with an inlet and outlets for discharging permeate and concentrate. In particular permeate is discharged through an outlet opening located centrally along the long axis of the tubular housing.

EP 0 937 492 A2 discloses a capillary filtration membrane element comprising a filter housing with an inlet, an outlet and a membrane compartment. To discharge the permeate the membrane compartment further comprises discharge lamellae, which guide the permeate to a centrally located discharge compartment.

DE 197 18 028 C1 describes a filtration system including an apparatus housing with membrane elements connected parallel to each other. The filtration apparatus further comprises a back-flush component, which allows to backflush one of the membrane elements while the others remain in filtration mode.

WO 2001/23076 A1 discloses an apparatus for purifying feed water, which is fed to bundles of hollow fibre membranes arranged within the apparatus. The feed water is introduced at the top of the apparatus into a perforated tube, which leads the feed water into the membranes. Filtrate is collected at the bottom and partially stored in a diaphragm tank for backwashing.

WO 2003/013706 describes a membrane element assembly with a hollow fiber membrane located in a vessel. The ends of the membranes open into respective collection headers. Feed connections are located on the side of the vessel applying feed to the side walls of the membrane fibers and withdrawing permeate through the fiber lumens. Filtrate is removed from the headers and waste is discharged through discharge ports located on the side of the vessel opposite to the feed ports.

WO 2006/047814 discloses a membrane element having a plurality of hollow fiber membranes extending between upper and lower headers. The fibers in the upper header open into a permeate collection chamber. The lower header has a plurality of aeration openings for feeding gas and/or liquid into the membrane element.

In known filtration systems membrane filtration elements for micro-, ultra- or nanofiltration are connected in series or in parallel in order to increase the membrane surface per required armatures. Filtration systems operated in dead end mode are less energy consuming and produce less concentrate to discharge than systems operated in cross-flow mode. Such dead end filtration systems, however, require more constructive effort as further flushing equipment for a backwash (also named backflush) mode is required, in which the filtration direction is reversed such that a possible fouling layer formed on the membranes surface is lifted and can be removed. In dead end applications with serial connected membrane filtration elements the membrane surface area is limited and does not exceed 200 m². Elements are difficult to remove and the filtration and backwash effectivity is reduced because the filtrate and the backwash water within a serial arrangement are not equally distributed along the filtration elements neither on the permeate nor on the concentrate side.

Therefore, it is an object of the invention to provide a filtration apparatus that facilitates a simpler design and at the same time achieves improved operation and performance characteristics by providing an equal pressure distribution while filtration and backwashing and by providing the opportunity to backwash the membrane by a short and strong impulse. This special backwash mode is hereinafter referred to as backshock. A particular object of the invention is thus to achieve more efficient and more effective filtration and backwash processes and to provide a larger total membrane surface per required armature.

These objects are achieved by a filtration apparatus for filtering fluids, such as gases or liquids, in particular raw water, comprising a top compartment, a filtration compartment and a bottom compartment, wherein the filtration compartment comprises a multiple of filtration elements arranged in parallel, the filtration elements further comprising at least one permeate collecting tube, wherein the permeate connecting tube is in fluid communication with the top compartment such that in filtration operation a continuous permeate flow into a permeate collecting chamber of the top compartment is provided and in backwash operation permeate collected in the permeate collecting chamber is flushed back through the filtration elements.

The objects are further achieved by a method for filtering fluids using the filtration apparatus comprising a top compartment, a bottom compartment as well as a filtration compartment, wherein a fluid to be filtered, such as gases or liquids, in particular raw water, is fed to the filtration compartment and filtered via filtration elements arranged in parallel within the filtration compartment and comprising at least one permeate collecting tube, wherein in filtration permeate continuously flows into a permeate collecting chamber of the top compartment and and in backwash operation permeate collected in the permeate collecting chamber is flushed back through the filtration elements or in forwardwash operation the fluid to be filtered is flushed through the filtration elements such that an overflow is generated in the filtration elements.

The filtration apparatus and the method for filtering allow for achieving high filtration capacities in a very simple and cost effective way. Particularly, the apparatus facilitates a compact and simple design with high filtration capacity. In particular the integration of a permeate collecting chamber permeate for backwashing avoids having to include further flushing equipment such as a separate tank. Furthermore, owing to the continuous permeate flow through the permeate collecting chamber the growth of microbiological organisms is reduced or completely avoided. The hygienic conditions inside the filtration apparatus are thus enhanced not only by cleaning the filtration elements via backwash but also by using an appropriate backwash medium excluding microbiological organisms, which may contaminate the filtration elements.

The following description concerns the apparatus as well as the methods proposed by the invention. In particular, preferred embodiments of the individual compartment, the connection between compartments as well as the fluid communications apply to the apparatus and the methods alike.

In the context of the present invention filtration mode the fluid to be filtered, preferably raw water, is fed to the filtration apparatus comprising at least one filtration element and is filtered by one filtration element. Retentate is held back on the retentate side of the filtration element and permeate flows through from the retentate side to the permeate side of the membrane. In particular, the permeate flows towards the permeate collecting tube. In backwashing mode the flow direction is reversed and permeate is fed to the filtration element in reverse direction in order to wash away retentate collected on the retentate side of the filtration element.

In one embodiment the filtration apparatus is composed of separate elements each including at least one of the compartments, i.e. the top compartment, the bottom compartment or the filtration compartment, which are assembled to form the filtration apparatus. Preferably at least the top compartment forms a separate element, which can be attached to the filtration compartment. Such a modular design allows for simple assembly and maintenance. In particular, with the top compartment being releasably attached to the filtration compartment filtration elements can simply be replaced or maintained.

In a further embodiment the filtration element comprise a filtration element for filtering fluids, such as gases or liquids, in particular raw water, comprises an element housing and at least one membrane arrangement comprising of at least one single membrane hollow fibre. The filtration element may comprise at least one permeate collecting tube arranged within the element housing. The at least one permeate collecting tube may further be arranged in a central and/or in an outer part of the filtration element. Arranging the permeate collecting tube in the central part of the filtration element allows for simpler construction and replacement. Arranging the permeate collecting tube in the outer part of the filtration element allows in filtration mode as well as in backwash mode for an even flow or pressure distribution across the filtration element.

In another embodiment the membrane arrangement of the filtration element comprises a multi bore membrane. The multi bore membrane preferably comprises more than one capillary, which runs in a channel along the longitudinal axis of the membrane arrangement or the filtration element, respectively. Particularly, the multi bore membrane comprises at least one substrate forming the channels and at least one active layer arranged in the channels forming the capillaries. Embedding the capillaries within a substrate allows forming a multi bore membrane, which are considerably easier to mount and mechanically more stable than membranes based on single hollow fibres. As a result of the mechanical stability, the multi bore membrane is particularly suitable for cleansing by an extraordinary strong backshock. In combination with the arrangements of the permeate colleting tube leading to an even pressure distribution within the filtration element, the overall performance and stability of the filtration element is further enhanced.

By using filtration elements arranged in parallel further comprising such multi bore membranes the filtration capacity of the filtration apparatus is enhanced significantly. One multi bore membrane filtration element having for instance a surface area of 40 square meters results for instance for 20 filtration elements inside one filtration apparatus in an effective surface area of 800 square meters. Hence the combination of a parallel filtration apparatus design with multibore membranes facilitates a compact apparatus design providing high filtration capacity. In preferred embodiments the filtration apparatus comprises at least 10 and particularly preferred at least 50 filtration elements in parallel. The multi bore membranes within the filtration elements may comprise seven or nine capillaries resulting in an effective membrane surface area of at least 100 square meters, preferred at least 300 square meters.

The substrate of the multi bore membrane can be made of at least one polymer, in particular at least one soluble thermoplastic polymer. The at least one polymer can be selected from polysulfone (PSU), polyethersulfone (PESU), polyphenylenesulfone (PPSU), polyvinylidene chloride (PVDC), polyvinylidene fluoride (PVDF), polyvinyl chloride (PVC), polyacrylonitrile (PAN), polyphenylenesulfone, polyarylether, polybenzim-idazole (PBI), polyetherimide (PEI), polyphenyleneoxide (PPO), polyimide (PI), polyetherketone (PEK), polyetheretherketone (PEEK), cellulose acetate and copolymers composed of at least two monomeric units of said polymers. Preferably the at least one polymer is selected from polyethersulfone (PESU), polysulfone (PSU), polyvinylidene chloride (PVDC), polyvinylidene fluoride (PVDF), cellulose acetate, polzacrylonitrile (PAN) and copolymers composed of at least two monomeric units of said polymer. The polymer can also be selected from sulfonated polymers selected from the group consisting of polyarylether, polyethersulfone (PESU), polysulfone (PSU), polyacrylonitrile (PAN), polybenzimidazole (PBI), polyetherimide (PEI); polyphenyleneoxide (PPO), polyvinyli-denfluoride (PVDF), polyimide (PI), polyetherketone (PEK), polyetheretherketone (PEEK), polyphenylenesulfone and copolymers composed of at least two monomeric units of said polymers. Suitable polymers are also for instance described in PCT/EP2010/057591.

More preferably the at least one polymer is selected from polysulfone (PSU) and polyethersulfone (PESU).

More preferably the at least one polymer is selected from polysulfone (PSU) and polyethersulfone (PESU).

The channels of the substrate may incorporate an active layer with a pore size different to that of the substrate or a coated layer forming the active layer. Suitable materials for the coated layer are polyoxazoline, polyethylene glycol, polystyrene, hydrogels, polyamide, zwitterionic block copolymers, such as sulfobetaine or carboxybetaine. The active layer can have a thickness in the range from 10 to 500 nm, preferably from 50 to 300 nm, more preferably from 70 to 200 nm. Preferably, the multi bore membranes utilized in the context of the present invention are designed with a pore sizes between 0.2 and 0.01 μm. In such embodiments the inner diameter of the capillaries can lie between 0.1 and 8 mm, preferred between 0.5 and 4 mm and particularly preferred between 0.9 and 1.5 mm. The outer diameter of the multi bore membrane can lie between 1 and 26 mm, preferred 2.3 and 14 mm and particularly preferred between 3.6 and 6 mm. Furthermore, the multi bore membrane can contain 2 to 94, preferably 3 to 19 and particularly preferred between 3 and 14 channels. Often multi bore membranes contain seven channels. The permeability range can lie between 100 and 10,000 L/m2hbar, preferably between 300 and 2,000 L/m2hbar.

Typically multi bore membranes of the type described above are manufactured by extruding a polymer, which forms a semi-permeable membrane after coagulation through an extrusion nozzle with several hollow needles. A coagulating liquid is injected through the hollow needles into the extruded polymer during extrusion, so that parallel continuous channels extending in extrusion direction are formed in the extruded polymer. Preferably the pore size on an outer surface of the extruded membrane is controlled by bringing the outer surface after leaving the extrusion nozzle in contact with a mild coagulation agent such that the shape is fixed without active layer on the outer surface and subsequently the membrane is brought into contact with a strong coagulation agent. As a result a membrane can be obtained that has an active layer inside the channels and an outer surface, which exhibits no or hardly any resistance against liquid flow. Herein suitable coagulation agents include solvents and/or non-solvents. The strength of the coagulations may be adjusted by the combination and ratio of non-solvent/solvent. Coagulation solvents are known to the person skilled in the art and can be adjusted by routine experiments. An example for a solvent based coagulation agent is N-methylpyrolidone. Non-solvent based coagulation agents are for instance water, iso-propanol and propylene glycol.

The membrane elements utilized in the context of the present invention can also be designed for microfiltration with a pore size greater 0.2 μm, for nanofiltration with a pore size between 0.01 and 0.001 μm of for reverse osmosis with a pore size of less than 0.001 μm. Particularly membranes adapted for reverse osmosis are described in WO 2012/146629 or PCT/EP2013/062232. A process for producing such membranes is for instance explained in WO 2011/051273.

The filtration element may further comprise a perforated tube arranged around the multi bore membrane arrangement. The perforations may be formed by holes or other openings located in regular or irregular distances along the tube. Preferably, the multi bore membrane arrangement is enclosed by the perforated tube. With the perforated tube the axial pressure distribution along the filtration element can be equalised in filtration and backwashing operation. Thus, the permeate flow is evenly distributed along the filtration element and hence the filtering effect can be increased.

The perforated tube may be arranged such that an annular gap is formed between the element housing and the perforated tube. Known membrane arrangements do not have a distinct border and the membrane element is directly embedded in a housing of the filtration element. This leads to an uneven pressure distribution in axial and radial direction as both the axial and radial flow are disturbed by the dense membrane arrangement. In contrast the filtration element according to the invention allows for evenly distributing the permeate flow along the filtration element and hence the filtering effect can be increased.

In a further embodiment the filtration elements including the multi-bore membrane arrangement are arranged for an in-out-operation or in operation operated in an in-out-operation. Here in-out-operation refers to the flow direction of the fluid to be filtered. In in-out-operation fluid to be filtered enters the capillaries of the multi-bore membrane and permeate exits the membrane via the substrate to the permeate collecting tube. Hence, fluid flow from inside the channels or capillaries to the outside of the channels or capillaries is achieved.

Thus, fluid to be filtered may be fed to the filtration compartment via a feed connection, which is preferably located in a lower part of a compartment housing of the filtration compartment. Feeding fluid to be filtered to the lower part of the compartment housing allows air to be vented on start up of the filtration apparatus. To facilitate such ventilation the filtration compartment may further comprise at least one aeration opening, which is preferably located in an upper part of the compartment housing. Thus air trapped in the filtration apparatus may be vented by filling the filtration compartment with fluid to be filtered.

In a further embodiment the permeate collecting tubes of the filtration elements are closed at the bottom end and open at the top end. This way the fluid flow within the filtration apparatus can be controlled in such a way that permeate flows into the top compartment and the retentate flows into the bottom compartment without cross contamination.

In a further embodiment the filtration compartment is connected to the top compartment via a top plate arranged to allow for permeate flow between the permeate collecting tubes of the filtration elements and the permeate collecting chamber. Preferably the permeate collecting tubes of the filtration elements are connected to the top plate via adapters, which allow for permeate flow between the permeate collecting tubes of the filtration elements and the permeate collecting chamber. Such adapters may be formed by adapter pieces which include sealing regions for fluid tight connection on either side of a central stopper region. Furthermore, the top plate may comprise openings for receiving the adapter pieces. In the assembled state the sealing regions of the adapter pieces may be in contact with the openings of the top plate on one side and with the permeate collecting tube of the filtration element on the other side. The connection with the top plate facilitates a fluid tight connection, which allows for permeate flow avoiding any contamination. Additionally the stopping region of the adapters provide a gap between the filtration elements and the top plate, which allows fluid to be filtered to enter the filtration element and in particular the capillaries of the membrane arrangement.

In a further embodiment the top compartment comprises means for producing a back shock of permeate collected within the top compartment and in particular the permeate collecting chamber. This way any fouling layer built up on the membrane can be removed and the filtration capacity can be enhanced. Furthermore, the back shock enables to use a pressurised flushing which reduces the required flushing volume. This in turn benefits the constructional aspect of having to provide less volume within the top compartment resulting in a very compact design of the filtration apparatus. Means for producing a back shock for instance comprise an aeration opening in the top region of the top compartment, through which a pressure shock, e.g. an air pressure shock, may be introduced into the top compartment thus reversing the permeate flow direction within the filtration apparatus. Preferably the means for producing a back shock are suitable to produce a permeate flow of at least 0.5 litre, preferably of at least 1 litre per square metre of a membrane surface area. For example an air pressure equipment producing at least 2 bar, preferably between 2 and 5 bar and particularly preferably between 2.5 and 3.5 bar, for example 3 bar of air pressure may be facilitated.

Further on the filtration apparatus may comprise a chemical dosing system connected to the permeate outlet of the top compartment. Such a chemical dosing system can further comprise a dosing pump and at least one valve which allows to add cleaning chemicals into the permeate collecting chamber for a chemically enhanced backwash operation.

In a further embodiment the bottom compartment is in fluid communication with the filtration elements, such that retentate is discharged into the bottom compartment. Preferably the bottom compartment is connected to a drain for discharging the retentate. Thus retentate can easily be discharge which is further promoted by the force of gravity due to the orientation of the filtration apparatus.

Furthermore, the filtration apparatus may comprise a recycling system connecting the drain of the bottom compartment with a feed inlet in the filtration compartment. Such a recycling system can further comprise a pump, a closing system and at least one valve, which allows to switch between draining and recycling for the forwardwash operation, or which allows to add cleaning chemicals into the recycling loop for a chemically enhanced forwardwash operation. In a further embodiment the filtration compartment is connected to the bottom compartment via a bottom plate arranged to allow for retentate flow between the filtration elements and the bottom compartment. Preferably, the filtration elements are mounted in openings arranged in the bottom plate. The openings may comprise a notch with sealing means, which receives the filtration elements. The connection with the bottom plate facilitates a fluid tight connection, which allows for retentate discharge. Additionally the stopping region of the adapters provides a gap between the filtration elements and the top plate, which allows fluid to be filtered to enter the filtration element and in particular the capillaries of the membrane arrangement from the top.

The filtration apparatus and the filtration elements can have cylindrical shape, wherein the cross-section can have any shape such as round, oval, triangular, square or some polygon shape. Preferred is a round shape, which leads to a more even flow and pressure distribution within the filtration apparatus and avoids collection of filtered material in certain areas such as corners for e.g. square or triangular shapes. The filtration elements and the membrane arrangements can have a length of 50 centimetres to 2 meters. The surface area of such membrane elements can lie between 5 and 100 square meters. Preferably the housing of the filtration compartment, the top compartment and the bottom compartment is made of steel, for instance standard steel available under material numbers 1.0036, 1.4301, 1.4306 (AISI 304L), 1.4404 (AISI 316L), 1.4571, 1.4462, nickel based alloys, for instance available under the trade name Hastelloy® C-276, titanium or glass fibre reinforced plastic. The steel may further be coated with a polyamide, for example available under the trade name Rilsan®.

In one implementation of the method for filtering fluids the filtration elements operate in in-out-operation. Here in-out-operation refers to the flow direction of the fluid to be filtered. In in-out-operation fluid to be filtered enters the capillaries of the multi-bore membrane and permeate exits the membrane via the substrate to the permeate collecting tube. Hence, fluid flow from inside the channels or capillaries to the outside of the channels or capillaries is achieved.

In a further implementation in backwash operation a back shock of permeate collected within the top compartment is produced. In a further implementation the back shock produces a back shock flow of permeate at least 0.5 litre per square metre of a membrane surface area.

In a further implementation, the permeate collected within the top compartment is prior to a backwash spiked with chemicals by a chemical dosing system in order to conduct a chemically enhanced backwash operation.

In a further implementation the bottom compartment is drained before backwash such that air enters the filtration elements. In order to vent the filtration elements an aeration opening arranged in a top area of the filtration compartment may be opened. If the filtration elements are drained the backwash operation is more effective and pressure losses are reduced, as an air-water-flow is present in the channels.

In a further implementation in forwardwash operation the fluid to be filtered is recycled back in the forwardwash operation. To generate in forwardwash an overflow in the filtration elements a valve to a drainage or a recycling system may be opened.

Further on the present invention is directed to the use of the filtration apparatus in a ultrafiltration, microfiltration or nanofiltration process for water treatment, such as drinking water treatment, waste water treatment or seawater desalination, concentration of pharmaceutical compositions, concentration of food compositions, water reclamation from waste water, power generation and potable water reuse devices, preferably for water treatment, such as drinking water treatment, waste water treatment and seawater desalination.

### BRIEF DESCRIPTION OF THE DRAWINGS

For a better understanding of the aforementioned embodiments of the invention as well as additional embodiments thereof, reference should be made to the Description of Embodiments below, in conjunction with the appended drawings showing:

FIG. 1 a longitudinal sectional view of a filtration apparatus including three compartments,

FIG. 2 a perspective view of the top compartment,

FIG. 3 a perspective view of the bottom compartment,

FIG. 4 a perspective view of the filtration compartment,

FIG. 5 a perspective view of a filtration element,

FIG. 6 detailed views of a multi bore membrane of FIG. 5,

FIG. 7 a cross-sectional view of the filtration element attached to a top plate of the top compartment and a bottom plate of the bottom compartment,

FIG. 8 a detailed view of the filtration element attached to a top plate of the top compartment, and

FIG. 9 a detailed view of the filtration element attached to a bottom plate of the bottom compartment.

Hereinafter, preferred embodiments of the present invention will be described with reference to the drawings. The drawings only provide schematic views of the invention. Like reference numerals refer to corresponding parts, elements or components throughout the figures, unless indicated otherwise.

### DESCRIPTION OF EMBODIMENTS

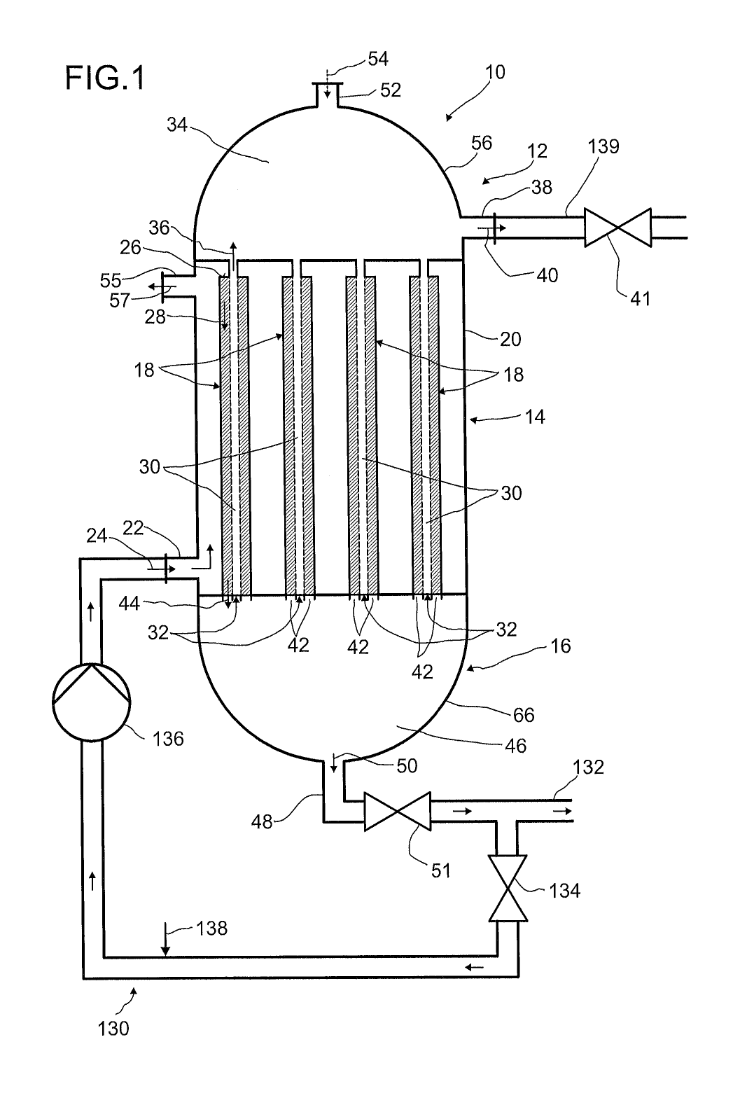

FIG. 1 shows a schematic, longitudinal sectional view of a filtration apparatus 10 composed of three compartments, namely a top compartment 12, a filtration compartment 14 and a bottom compartment 16.

The filtration compartment 14 of the filtration apparatus 10 is arranged between the top compartment 12 and the bottom compartment 16. The filtration compartment 14 comprises filtration elements 18, which are arranged in parallel inside a compartment housing 20. The filtration compartment 14 further comprises a feed 22, through which a fluid to be filtered, such as raw water, is fed to the filtration elements 18 inside the filtration compartment 14 as indicated by arrow 24.

The filtration elements 18 are arranged such that liquid to be filtered enters the filtration elements 18 from the top of the filtration compartment 14 as indicated by arrow 26. Inside the filtration elements 18 the liquid to be filtered separated into filtrate or permeate and retentate or concentrate as indicated by arrow 28. Permeate is collected in a permeate collecting tube 30, which are closed by a seal 32 towards the bottom compartment and open towards the top compartment. Permeate is thus channelled into a back-shock volume 34 as indicated by arrow 36. Thus, the permeate collecting chamber 34 fills with permeate and excess permeate is released through a permeate outlet 38 with a valve 41 through which the permeate is conducted as indicated by arrow 40. Optionally, cleaning chemicals known to the person skilled in the art may be dosed into the permeate collected in the permeate collecting chamber 34 via dosage 138, which is located between the permeate outlet 38 and the valve 41.

Retentate is released through bottom openings 42 from the filtration elements 18 into a retentate collecting chamber 46 in the bottom compartment 16 as indicated by arrow 44. The bottom compartment 14 further comprises a drain 48 with a valve 51 through which the retentate is released into the drainage 132 as indicated by arrow 50. Alternatively the filtration apparatus 10 may be suitable to realise a forwardwash mode in which the cleaning medium, such as a cleaning liquid including cleaning chemicals, is recycled. For such an extended forwardwash mode the filtration apparatus 10 may comprise a recycling system 130, which includes a valve 134 and a pump 136. Thus in order to recycle a cleaning liquid in forwardwash operation the drain 48 includes a branching for the recycling system 130, which may be opened by valve 134. In such operation the drainage 132 is block for example by a further valve. The pump 136 pumps the recycled cleaning medium back into the filtration compartment 14. Optionally cleaning chemicals known to the person skilled in the art may be added to the recycled cleaning medium via dosage 138, which is located in the branch of the recycling system 130 between valve 134 and pump 136.

The compartments 12, 14, 16 of the filtration apparatus 10 further comprise aeration openings 52, 55 allowing air to enter or exit the inside of the filtration apparatus 10 as indicated by arrows 54, 57. The arrows 24, 26, 28, 36, 44, 50, 40 indicate the fluid flow in filtration mode. In back-flush mode the fluid flow is reversed such that permeate is released under pressure from the permeate collecting chamber 34 in reverse direction through the filtration elements 18. The backwash mode is initiated by applying pressure via the aeration opening 52 in flow direction 54 by for instance inducing air pressure. The pressure level producing such a back shock may be at least 1 bar, for example 3 bar. By reversing the fluid flow direction permeate is induced into the permeate collecting tube 30 and the filtration elements 18 are penetrated by the permeate in reverse direction, thus removing any residues or contamination of the filtration elements 18 which diminish the filtration effect.

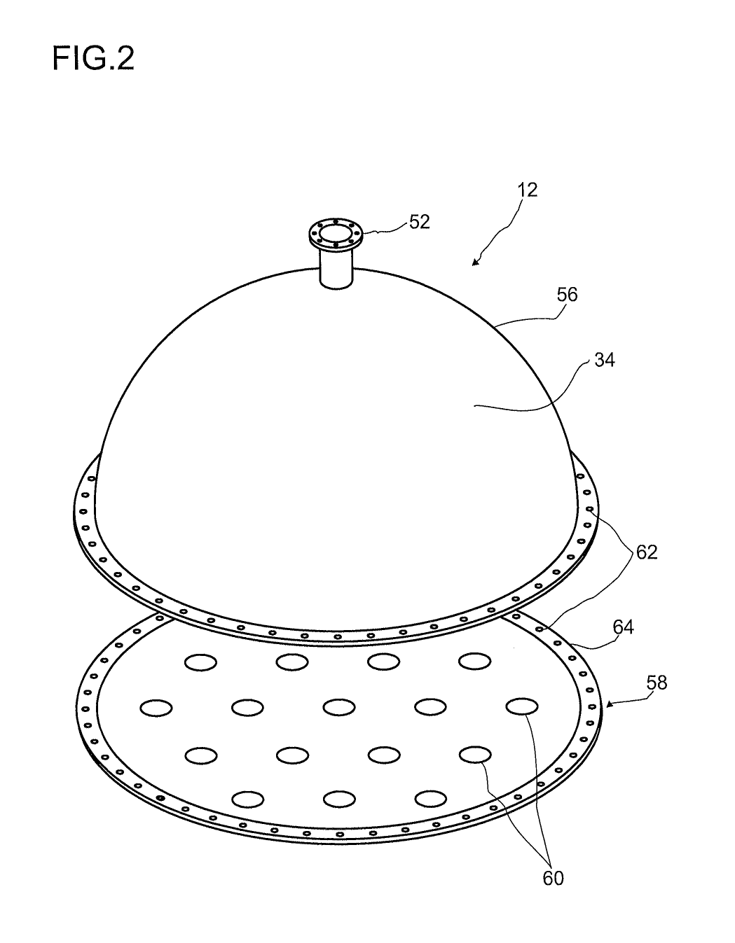

The compartments 12, 14, 16 may be built as separate elements, which are assembled to form the filtration apparatus 10. Thus, the filtration apparatus 10 is composed of separate parts, which are connected together in a fluid tight manner. Furthermore, the built up of the filtration apparatus allows for different wash operations to be carried out, in particular a forwardwash operation, an extended forwardwash operation with recycling system 130 and chemical dosing 138, a backwash or backshock operation and a chemically enhanced backwash operation with a chemical dosing 139. The individual compartments 12, 14, 16 are described in more detail with respect to FIGS. 2, 3 and 4.

FIG. 2 shows a perspective view of the top compartment 12.

The top compartment 12 comprises a cover shell 56 which forms the permeate collecting chamber 34 and a top plate 58, which separates the permeate collecting chamber 34 from the filtration compartment 14. The cover shell 56 and the top plate 58 may be connected to each other via fix or releasable connection means. The cover shell 56 is formed by a round head or semi-circular shell with the aeration opening 52 for allowing air to enter or exit the inside of the filtration apparatus 10 in the top position. The top plate 58 has through-holes 60 for connecting the permeate collecting tubes 30 allowing for permeate flow between from the filtration compartment 14 into the permeate collecting chamber 34. Furthermore, the top plate 58 and the cover shell 56 have connection means 62 and sealing means 64 for a tight connection between the two parts. In the embodiment of FIG. 2 the connection means 62 are formed by holes which allow for connection via screws. However, the connection means 62 can be formed by any connection means 62 known to the person skilled in the art, which allow for tight connection. The sealing means 64 may be formed by e.g. an O-ring, a gasket or other suitable seals.

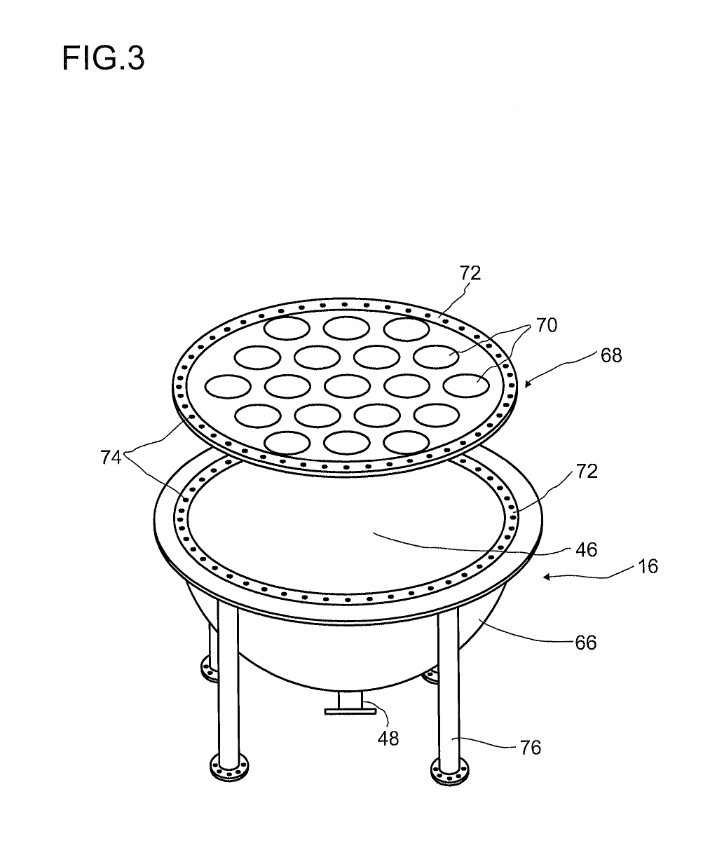

FIG. 3 shows a perspective view of the bottom compartment 16.

The bottom compartment 16 comprises a bottom shell 66 which forms the retentate collecting chamber 46 and a bottom plate 68, which separates the retentate collecting chamber 46 from the filtration compartment 16. The bottom shell 66 and the bottom plate 68 may be connected to each other via fix or releasable connection means. The bottom shell 66 is formed by a round head or semi-circular shell with the drain 48 in the bottom position. The bottom plate 68 has through-holes 70 for connecting the filtration elements 18 allowing retentate to flow from the filtration compartment 16 into the retentate collecting chamber 66. Furthermore, the bottom plate 68 and the bottom shell 66 have connection means 72 and sealing means 74 for a tight connection between the two parts. In the embodiment of FIG. 3 the connection means 72 are formed by holes which allow for connection via screws. However, the connection means 72 can be formed by any connection means 72 known to the person skilled in the art, which allow for tight connection. The sealing means 74 may be formed by e.g. an O-ring, a gasket or other suitable seals. The bottom compartment 16 is supported by a stand 76 for keeping the filtration apparatus 10 in the upright position.

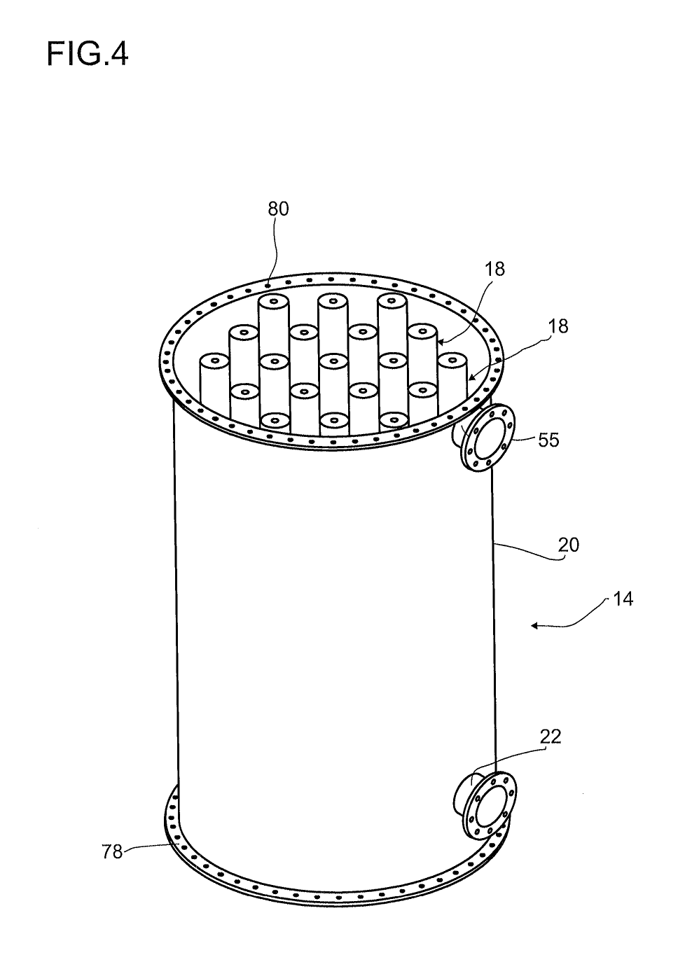

FIG. 4 shows a perspective view of the filtration compartment 14.

The filtration compartment 14 comprises several filtration elements 18, which are arranged in parallel inside the compartment housing 20. The compartment housing 20 has cylindrical form and is open at the top and bottom end such that a fluid communication with the top and bottom compartment 12, 16 can be established. For connection to the bottom and top compartment 12, 16 the filtration compartment 14 further comprises connection means 78, 80 on either side of the compartment housing 20. The feed 22 is arranged in a bottom area of the filtration compartment 14. The aeration opening 55 for allowing air to enter or exit the inside of the filtration apparatus 10 is arranged in a top area of the filtration compartment 14.

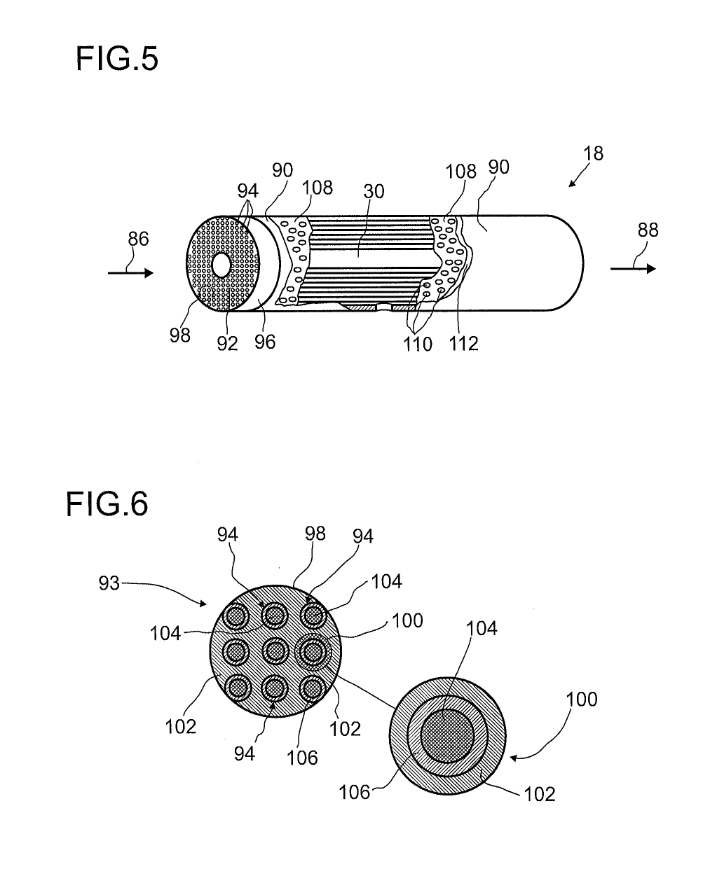

FIG. 5 shows a perspective view of a filtration element 18.

In operation, the filtration element 18 shown in FIG. 5 is oriented vertically, i.e. the longitudinal axis of the filtration element 18 or the permeate collecting tube 30 is arranged parallel to the longitudinal axis of the filtration compartment 14 as shown in FIGS. 1 and 4. The filtration element 18 comprises an element housing 90, a multi bore membrane arrangement 92 particularly suitable for microfiltration, ultrafiltration or nanofiltration. The multi bore membrane arrangement 92 comprises of several but at least one multi bore membranes 93 explained in more detail with reference to FIG. 6. The multi bore membrane 93 includes several capillaries 94, which act as filter medium and extend along the longitudinal axes of the filtration element 18. The element housing 90, the permeate collecting tube 30 and the multi bore membrane arrangement 92 are fixed at each end in membrane holders 96 comprising a resin preferably consisting of epoxy, in which the element housing 90, the permeate collecting tube 30 and the multi bore membrane arrangement 92 are embedded.

In the configuration shown in FIG. 5 fluid to be filtered, such as raw water, is fed to the filtration element 18 from the left as indicated by arrow 86. The fluid to be filtered is at least partly filtered through the filtration element 18 and permeate is collected in the permeate collecting tube 30. Brine or concentrate, which is not filtered through the filtration element 18, is in the configuration shown in FIG. 5 discharged to the right as indicated by arrow 88.

Further with reference to FIG. 5, the multi bore membrane arrangement 92 comprises a permeate collecting tube 30, which is arranged within the filtration element 18. In particular, the permeate collecting tube 30 is arranged at the centre or in a central part of the filtration element 18 and comprises a tube including openings (not shown), which allow permeate to flow into the permeate collecting tube 30 conducting the permeate out of the filtration element 18. This location allows for easy assembly and construction of the filtration apparatus 10 and the filtration elements 18 to be easily be remounted.

The filtration element 18 as depicted in the embodiment of FIG. 5 further comprises a perforated tube 108 enclosing the multi bore membrane arrangement 92. The perforated tube 108 encloses the permeate collecting tube 30. The perforation of the tube 108 can be of any kind. In the example of FIG. 5 the perforation comprises holes 110 in the tube 108, which allow for liquid flow. With the perforated tube 108 enclosing the multi bore membrane arrangement 92 an annular gap 112 is formed between the element housing 90 and the perforated tube 108. In operation, i.e. in filtration or backwash operation, this allows for an even distribution of water within the filtration element 18. In particular an even pressure distribution is also reached in axial flow direction.

In other embodiments the permeate collecting tube 30 can be arranged at an outer circumferences of the filtration element 18. This location of the permeate collecting tube 30 in combination with the perforated tube 108 provides for an even pressure distribution within the multi bore membrane arrangement 92. In particular, the cross-section of the multi bore membrane arrangement 92, through which the permeate flow flows through, is not reduced and thus, the flow velocity remains even across the whole cross-section of the multi bore membrane arrangement 92. In contrast, when placing the permeate collecting tube 30 in the centre of the multi bore membrane arrangement 92 the cross-section reduces towards the central tube and the flow velocity increases, which results in a higher pressure applied to the capillaries 94 close to the central tube. Thus, the disadvantages resulting from the central location of the permeate collecting tube 30 are abandoned and an even pressure distribution in radial direction can be achieved.

FIG. 6 shows a detailed view of a single multi bore membrane 93 as indicated by the circle 98 in FIG. 6 and a further detailed view of one capillary 94 of the multi bore membrane 22 as indicated by circle 100 in FIG. 2.

The capillaries 94 include a porous substrate 102 forming channels 104, which extend longitudinally along the length of the multi bore membrane 93. Inside the channels 104 an active layer 106 is arranged as filtration layer, which can either be incorporated into a substrate 102 with a different pore size or which can be formed by a coating. The capillaries 94 are thus embedded in the porous substrate 102, which aids stability and avoids capillary rupture.

The porous substrate 108 of the multi bore membrane 93 is formed by a polymer, such as polysulphone type polymers, cellulose acetate, polyacrylonitrile, polyvinylidene. For example polyethersulfon or polysulfon are used to form the porous substrate 108 by extrusion, in particular by wet spinning. In wet spinning a suitable polymer is dissolved in a solvent, optionally adding additives and extruded through a spinneret for forming the multi bore membrane 93. After extrusion the membrane is coagulated and dissolvable components are removed. Such multi bore membranes 93 having an outer diameter of for instance 4 mm include for instance seven capillanes 94 with an inner diameter of 0.9 mm, and a pore size of 0.02 μm. Other multi bore membranes 93 having an outer diameter of for instance 6 mm and allowing for higher sediment concentrations for instance include seven capillaries 94 with an inner diameter of 1.5 mm, and a pore size of 0.02 μm.

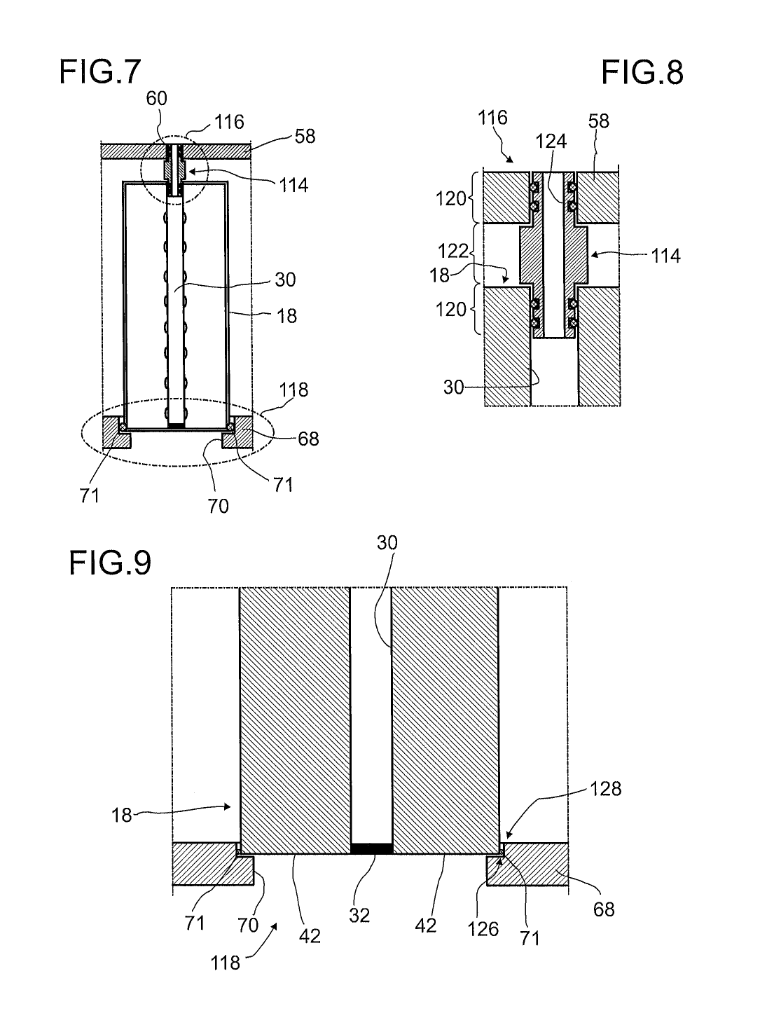

FIG. 7 shows a longitudinal-sectional view of the filtration element 18 attached to the top plate 58 of the top compartment 12 and the bottom plate 68 of the bottom compartment 16.

The filtration element 18 separates the fluid to be filtered into permeate and retentate, wherein the fluid to be filtered is fed to the capillaries 94 of the membrane arrangement 92, permeate is collected in the permeate collecting tube 30 and retentate is kept in the capillaries 94. In order to discharge the permeate into the top compartment 12 the permeate collecting tube 30 is connected to through-holes 60 in the top plate 58 allowing permeate to flow from the filtration compartment 14 into the permeate collecting chamber 34. The connection is established via adapter pieces 114, which are described in more detail with respect to FIG. 8.

FIG. 8 shows a detailed view of the filtration element 18 attached to a top plate 58 of the top compartment 12 via adapter pieces 114.

The adapter pieces 114 include sealing regions 120 and a stopper region 122. The sealing regions 120 are arranged on each side of the stopper region 122. Furthermore the sealing regions 120 are in contact with the through-hole 60 in the top plate 58 on one side and with the permeate collecting tube 30 of the filtration element 18 on the other side. The sealing regions 120 further comprise sealing means 121 such as O-rings, gaskets or the like to establish a fluid tight connection. The stopper region 122 includes a thickening forming notches which the filtration element 18 and the top plate 58 rest upon. In the centre of the adapter piece 114 a channel 124 is arranged, which allows for fluid communication and hence permeate flow between the permeate collecting tube 30 and the permeate collecting chamber 34.

Further with reference to FIG. 7, in order to discharge the retentate from the filtration compartment 14 into the bottom compartment 16 the capillaries 94 of the membrane arrangement 92 are connected to through-holes 70 forming bottom openings 42 in the bottom plate 68 for retentate to flow from the filtration compartment 14 into the retentate collecting chamber 46 and the drain 48. Details regarding the bottom connection of the filtration element 18 are described in more detail with respect to FIG. 9.

FIG. 9 shows a detailed view of the filtration element 18 attached to the bottom plate 68 of the bottom compartment 16.

The bottom plate 68 comprises a notch 126 with sealing means 128 such as an O-ring, a gasket or other suitable sealing means. The through-hole 70 and the notch 126 are arranged such that the filtration element 18 tightly fits into the notch 126 thus being supported by the notch. The permeate collecting tube 30 has a seal 32 at the bottom end in order to preclude permeate to mix with the retentate flow. Thus, it is only the membrane arrangement 92 with its capillaries 94 that is in fluid communication with the bottom part through bottom openings 42.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings and those encompassed by the attached claims. The embodiments were chosen and described in order to explain the principles of the invention and its practical applications, to thereby enable others skilled in the art to utilize the invention and various embodiments with various modifications as are suited to the particular use contemplated.

### LIST OF REFERENCE NUMERALS

| | |
|---|---|
| 10 | filtration apparatus |
| 12 | top compartment |
| 14 | filtration compartment |
| 16 | bottom compartment |
| 18 | filtration elements |
| 20 | compartment housing |
| 22 | feed |
| 24 | flow arrow |
| 26 | flow arrow |
| 28 | flow arrow |
| 30 | permeate collecting tube |
| 32 | seal |
| 34 | permeate collecting chamber |
| 36 | flow arrow |
| 38 | permeate outlet |
| 40 | flow arrow |
| 41 | valve |
| 42 | opening |
| 44 | flow arrow |
| 46 | retentate collecting chamber |
| 48 | drain |
| 50 | flow arrow |
| 51 | valve |
| 52 | aeration opening |
| 54 | flow arrow |
| 55 | aeration opening |
| 56 | cover shell |
| 57 | flow arrow |
| 58 | top plate |
| 60 | through-holes |
| 62 | connection means |
| 64 | sealing means |
| 66 | bottom shell |
| 68 | bottom plate |
| 70 | through-holes |
| 72 | connection means |
| 74 | sealing means |
| 76 | stand |
| 78 | connection means |
| 80 | connection means |
| 86 | flow arrow |
| 88 | flow arrow |
| 90 | element housing |
| 92 | multi bore membrane arrangement |
| 93 | multi bore membrane |
| 94 | capillaries |
| 96 | membrane holders |
| 98 | indication circle |
| 100 | indication circle |
| 102 | substrate |
| 104 | channels |
| 106 | active layer |
| 108 | perforated tube |
| 110 | holes |
| 112 | annular gap |
| 114 | adapter piece |
| 116 | indication circle |
| 118 | indication circle |
| 120 | sealing regions |
| 122 | stopper region |
| 124 | channel |
| 126 | notch |
| 128 | sealing means |
| 130 | recycling system |
| 132 | drainage |
| 134 | valve |
| 136 | pump |
| 138 | dosing |
| 139 | dosing, dosage |

1-15. (canceled)

16. A filtration apparatus for filtering fluids comprising:
a top compartment, a filtration compartment, and a bottom compartment;
wherein the filtration compartment comprises a plurality of filtration elements arranged in parallel and a feed through which a fluid to be filtered is fed to the filtration elements inside the filtration compartment,
wherein the bottom compartment is connected to a drain for discharging retentate,
the filtration elements further comprising at least one permeate collecting tube, wherein the permeate collecting tube is in fluid communication with the top compartment such that in a filtration operation a continuous permeate flow into a permeate collecting chamber of the top compartment is provided and in a backwash operation permeate collected in the permeate collecting chamber is flushed back through the filtration elements,
wherein the filtration compartment is connected to the top compartment via a top plate configured to allow for permeate flow between the permeate collecting tubes of the filtration elements and the permeate collecting chamber,
wherein the filtration compartment is connected to the bottom compartment via a bottom plate arranged to allow for retentate flow between the filtration elements and the bottom compartment, and
wherein the filtration elements are mounted in openings arranged in the bottom plate, and retentate is released through the bottom openings from the filtration elements into a retentate collecting chamber in the bottom compartment.

17. The filtration apparatus of claim 16, composed of separate elements including at least one of the compartments.

18. The filtration apparatus of claim 16, wherein the filtration element comprises a filtration element for filtering fluids with an element housing and at least one membrane element comprising a multi bore membrane arrangement.

19. The filtration apparatus of claim 18, wherein the filtration elements including the multi-bore membrane arrangement are arranged for an in-out-operation.

20. The filtration apparatus of claim 16, wherein the permeate collecting tubes of the filtration elements are closed at a bottom end and open at a top end.

21. The filtration apparatus of claim 16, wherein the filtration elements are arranged such that liquid to be filtered enters the filtration elements from the top of the filtration compartment.

22. The filtration apparatus of claim 16, wherein the top compartment comprises means for producing a back-shock with permeate collected within the top compartment.

23. The filtration apparatus of claim 22, wherein the means for producing a back shock is configured to produce a back-shock flow of permeate of at least 0.5 liter of a membrane surface.

24. The filtration apparatus of claim 16, wherein the bottom compartment is in fluid communication with the filtration elements, such that retentate is discharged into the bottom compartment.

25. A method for filtering fluids using the filtration apparatus including a top compartment, a bottom compartment, and a filtration compartment, the method comprising:
feeding a fluid to be filtered through a feed to the filtration compartment and filtered via filtration elements, which are arranged in parallel within the filtration compartment and comprise at least one permeate collecting tube;
filtration permeate continuously flowing into a permeate collecting chamber of the top compartment and in a backwash operation permeate collected in the permeate collecting chamber is flushed back through the filtration elements or in a chemically enhanced backwash operation where chemicals are dosed into the permeate collecting chamber prior to a backwash operation or in a forwardwash operation the fluid to be filtered is flushed through the filtration elements such that an overflow is generated in the filtration elements or in a chemically enhanced forwardwash operation where chemicals are dosed into the recycling system during forwardwash operation,
releasing retentate through bottom openings from the filtration elements into a retentate collecting chamber in the bottom compartment, and
releasing retentate through a drain which the bottom compartment comprises.

26. The method for filtering fluids of claim 25, wherein the filtration elements operate in in-out-operation.

27. The method for filtering fluids of claim 25, wherein the bottom compartment is drained before backwash such that air enters the retentate side of the filtration elements.

28. The method for filtering fluids of claim 25, wherein liquid to be filtered enters the filtration elements from the top of the filtration compartment.

29. The method for filtering fluids of claim 25, wherein in forwardwash operation the fluid to be filtered is recycled back in to the forwardwash operation.

30. Use of a filtration apparatus according to claim 16 in an ultrafiltration, microfiltration, or nanofiltration process for water treatment.
